(19) United States
(12) Patent Application Publication
(10) Pub. No.: US 2016/0123050 A1
(43) Pub. Date: May 5, 2016

(54) DEVICE AND METHOD FOR SECURING PANEL CABINETS AGAINST BREAK-IN OR THEFT

(71) Applicant: Branch Communications LLC, Tulsa, OK (US)

(72) Inventors: Jamie EARP, Charlotte, NC (US); James McCOY, Tulsa, OK (US); Blake HOOPER, Oklahoma City, OK (US); Chris PRESCOTT, Flower Mound, TX (US)

(73) Assignee: Branch Communications LLC

(21) Appl. No.: 14/927,970

(22) Filed: Oct. 30, 2015

Related U.S. Application Data
(60) Provisional application No. 62/072,678, filed on Oct. 30, 2014.

(51) Int. Cl. E05C 7/04; E05C 21/00; E05C 1/10; E05C 19/00; E05C 19/18

(52) U.S. Cl. CPC E05C 7/04; E05C 19/003; E05C 19/188; E05C 1/10; E05C 21/00

(57) ABSTRACT

A locking apparatus and method for securing panel cabinets. The locking apparatus includes a mounting plate that includes at least one slot; and a support bracket that is projectable substantially diagonally upward from one end of the mounting plate, extend horizontally in parallel to the mounting plate, and is then projectable substantially diagonally downward to an opposing end of the mounting plate, wherein the mounting plate and the support bracket includes a frame that is placed on a cabinet. The support bracket may further include at least one crossover bracket that is configured to accept and hold at least one crossover tube and is further configured to accept a lock to hold the at least one crossover bracket and the at least one crossover tube together. The frame may be removably placed over a mounting bracket.

### CROSS REFERENCE TO PRIOR APPLICATIONS

This application claims priority to and the benefit thereof from U.S. provisional patent application No. 62/072,678, filed Oct. 30, 2014, titled “Device and Method for Securing Panel Cabinets Against Break-in or Theft,” the entirety of which is hereby incorporated herein by reference.

### FIELD OF THE DISCLOSURE

This disclosure is directed to locking apparatus and methods for securing panel cabinets.

### BACKGROUND OF THE DISCLOSURE

Telecommunications towers, such as those provided by wireless and cellular service providers, typically include large cabinets that store components for operating the tower, such as the batteries, wiring, etc. These towers are typically located in remote locations. There has been an increase in thefts of such internal components. Due to the remote location of the cabinets, it is often difficult to respond quickly to such thefts. Furthermore, theft of components such as batteries can have a significant impact on operation of telecommunication towers.

There is an unfulfilled need for a way to secure telecommunication tower cabinets to prevent or deter theft of the internal components of telecommunication towers.

### SUMMARY OF THE DISCLOSURE

In an aspect of the present disclosure, a locking apparatus for securing a panel cabinet includes a mounting plate that includes: at least one slot; a support bracket that is projectable substantially diagonally upward from one end of the mounting plate, extend horizontally in parallel to the mounting plate, and is then projectable substantially diagonally downward to an opposing end of the mounting plate; and a saddle bracket that includes at least one saddle bracket connection ear is configured to be attachable to the support bracket, wherein the mounting plate, the support bracket, and the saddle bracket includes a frame that is placed on top of the panel cabinet.

The support bracket may include at least one handle for aiding placement and removal of the locking apparatus. The support bracket may further include at least one slot that is configured to slidably accept the at least one saddle bracket connection ear.

The mounting plate may include an upper portion; and a lower portion, wherein the upper portion includes at least one slot, wherein the lower portion may include at least one lock attachment clip that is configured to slidably fit into the at least one slot on the upper portion to affix the upper portion to the lower portion, wherein the lower portion is configured to be embedded into the ground, and wherein once the lower portion is embedded into the ground, the upper portion is placed on top of the lower portion and a lock is placed on the at least one lock attachment clip.

The locking apparatus may further include at least one bracket leg that protrudes forward from the mounting plate.

The locking apparatus may further include a mounting bracket that is configured to be removably attached to the mounting plate.

The mounting bracket may further include at least one clip that is configured to slidably fit into the at least one slot on the mounting plate.

The mounting bracket may be configured to be affixed to a ground by a fastener.

The mounting bracket may be configured to be welded to an existing platform grating.

The lock may be placed on the at least one clip once the at least one clip slidably fit into the at least one slot on the mounting plate to affix the mounting bracket and the mounting plate.

The fastener may include: a push button; a pin; a lock; a clip; a clamp; a bolt; or a screw.

The support bracket may include at least one slot wherein the at least one slot is configured to slidably accept the at least one saddle bracket connection ear.

Once the at least one saddle bracket connection ear is slidably fit into the at least one slot, a lock may be placed on the connection ear to affix the saddle bracket to the support bracket.

The saddle bracket may include: at least one longitudinal member that is configured to stretch longitudinally on top of the cabinet; and at least one support member that is projectable downward to a bend so that it prevents removal of the locking apparatus from the cabinet.

In an another aspect of the present disclosure, a locking apparatus for securing a panel cabinet includes: a mounting plate that includes at least one slot; and a support bracket that is projectable substantially diagonally upward from one end of the mounting plate, extend horizontally in parallel to the mounting plate, and is then projectable substantially diagonally downward to an opposing end of the mounting plate, wherein the mounting plate and the support bracket includes a frame that is placed on the panel cabinet.

The support bracket may further include at least one crossover bracket that is configured to accept and hold at least one crossover tube and is further configured to accept a lock to hold the at least one crossover bracket and the at least one crossover tube together.

In an embodiment of the present disclosure, two replicates of the frame may be configured to be placed on both front and back of the cabinet, and wherein the two replicates of the frame are further configured to be removably attached to each other via the crossover tube.

The frame may be configured to be removably placed over a mounting bracket.

In an aspect of the present disclosure, a method of securing a panel cabinet includes: providing a mounting plate that includes at least one slot; and attaching a support bracket to the mounting plate, the support bracket being configured to project substantially diagonally upward from one end of the mounting plate, extend horizontally in parallel to the mounting plate, and is then projectable substantially diagonally downward to an opposing end of the mounting plate, wherein the mounting plate and the support bracket includes a frame that is configured to be placed over the panel cabinet.

The method may further include a mounting bracket that is configured to be removably attached to the mounting plate.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a front view of an example of a locking apparatus in accordance with the principles of the present disclosure.

FIG. 2 shows a close up of a perspective back view of the locking apparatus in FIG. 1.

FIG. 3 shows a front perspective view of another example of a locking apparatus in accordance with the principles of the present disclosure.

FIG. 4 shows a front view of the locking apparatus in FIG. 3.

FIG. 5 shows a perspective back view of the locking apparatus in FIG. 3

FIG. 6 shows a close up of a perspective back view of the locking apparatus in FIG. 3

FIG. 7 shows a close-up of a bottom back view of the locking apparatus in FIG. 3.

FIG. 8 shows a front view of yet another example of a locking apparatus in accordance with the principles of the present disclosure.

FIG. 9 shows a side view of the locking apparatus in FIG. 8.

FIG. 10 shows a close-up view of the lock-in mechanism of the locking apparatus in FIG. 8.

FIG. 11 shows a close-up of the front view of the locking apparatus in FIG. 8.

FIG. 12 shows a close-up of the mounting plate of the locking apparatus in FIG. 8.

FIG. 13 shows a close-up of the mounting bracket of the locking apparatus in FIG. 8.

FIG. 14 shows a front view of yet another example of a locking apparatus in accordance with the principles of the present disclosure.

FIG. 15 shows a close-up view of the lock-in mechanism of the locking apparatus in FIG. 14.

FIG. 16 shows a close-up view of the lock detail of the locking apparatus in FIG. 14.

FIG. 17 shows a close-up of the mounting bracket of the locking apparatus in FIG. 14.

FIG. 18 shows a front view of yet another example of a locking apparatus in accordance with the principles of the present disclosure.

FIG. 19 shows a close-up view of the lock-in mechanism of the locking apparatus in FIG. 18.

FIG. 20 shows an exploded view of the mounting plate of the locking apparatus in FIG. 18.

FIG. 21 shows an upper portion of the locking apparatus in FIG. 18.

FIG. 22 shows an exploded view of the locking apparatus in FIG. 3.

### DETAILED DESCRIPTION OF THE DISCLOSURE

Some embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, these embodiments are provided for the thorough and complete understanding of the present disclosure, and completely conveying the scope of the present disclosure to those skilled in the art.

The terms “including,” “comprising” and variations thereof, as used in this disclosure, mean “including, but not limited to,” unless expressly specified otherwise.

The terms “a,” “an,” and “the,” as used in this disclosure, means “one or more”, unless expressly specified otherwise.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single device or apparatus is described herein, it will be readily apparent that more than one device or apparatus may be used in place of a single device or apparatus. Similarly, where more than one device or apparatus is described herein, it will be readily apparent that a single device or apparatus may be used in place of the more than one device or apparatus. The functionality or the features of a device may be alternatively embodied by one or more other devices which are not explicitly described as having such functionality or features.

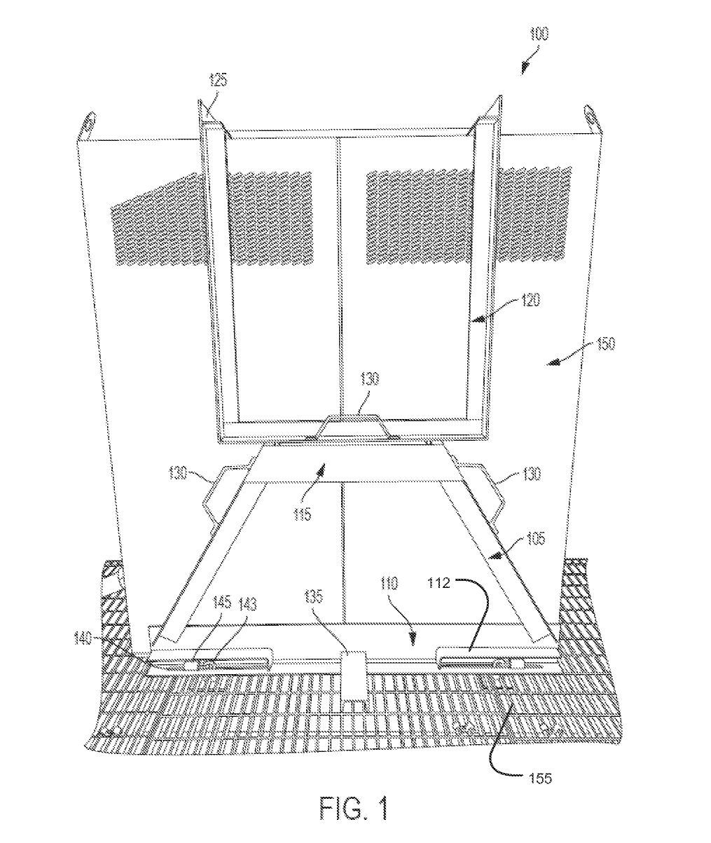

FIG. 1 shows a front view of an example of a locking apparatus 100 in accordance with the principles of the present disclosure. As shown in FIG. 1, the locking apparatus 100 includes a mounting plate 110, a support bracket 105 that is projectable substantially diagonally upward from an edge of the mounting plate 110 and includes at least one slot (not shown), and a saddle bracket 120 that includes at least one saddle bracket connection ear (shown as e.g., 323 in FIG. 10), wherein the at least one saddle bracket connection ear is configured to slide into the at least one slot of the support bracket 105 to connect the saddle bracket 120 and the support bracket 105, and wherein the support bracket 105 includes at least one handle for aiding the placement and removal of the locking apparatus 100 from a cabinet 150. The handle may include around 2.5 inches in height and 10 inches in length.

The locking apparatus 100 may include at least one lock (shown as e.g. 355 in FIG. 10), wherein the at least one lock may be placed between a hole in the at least one saddle bracket connection ear once the at least one saddle bracket connection ear is sled into the at least one slot of the support bracket 105.

The locking apparatus 100 may include at least one bracket leg 135 that protrudes forward from the mounting plate 110 and acts as a leverage to prevent the removal of locking apparatus 100.

The mounting plate 110 may include at least one slot 140 to engage with at least one mounting bracket 143. The at least one mounting bracket 143 may be welded an existing platform grating 155. Alternatively, the at least one mounting bracket 143 may be affixed to a ground. The at least one mounting bracket 143 may be affixed to the ground via e.g., an adhesive, a screw, a fastener, a nail, and the like. Once the at least one mounting bracket 143 is engaged with the at least one slot 140, at least one lock 145 may be placed through a hole in the at least one mounting bracket 143 to affix the mounting bracket 143 and mounting plate 110 together.

The mounting plate 110 may include at least one bent plate 112 which prevents easy access to the lock 145. The bent plate may include 3/16 inch by 2 inch by 1 to ½ inches.

The support bracket 105 may further include a plurality of metal beams that form a triangular or rectangular shape configuration at an angle. The angle may include ½ inch by 2 inch or ½ inch by 3/16 inch. The support bracket 105 may include an upside down U-shape wherein one end of the support bracket 105 is welded to one end of the mounting plate 110 and the other end of the support bracket 105 is welded to the opposing end of the mounting plate 110 to create the U-shape.

The support bracket 105 may include a plate 115 for concealing the at least one saddle bracket connection ear, the at least one slot of the support bracket 105, and the lock that connects the at least one saddle bracket connection ear and the at least one slot of the support bracket 105.

The mounting plate 110, the support bracket 105, the saddle bracket 120, at least one bracket leg 135, the at least one bent plate 112, the plate 115, and the bracket connection ear may include e.g., a metal, steel, iron, carbon fiber, and the like. These parts may further be galvanized with e.g., zinc.

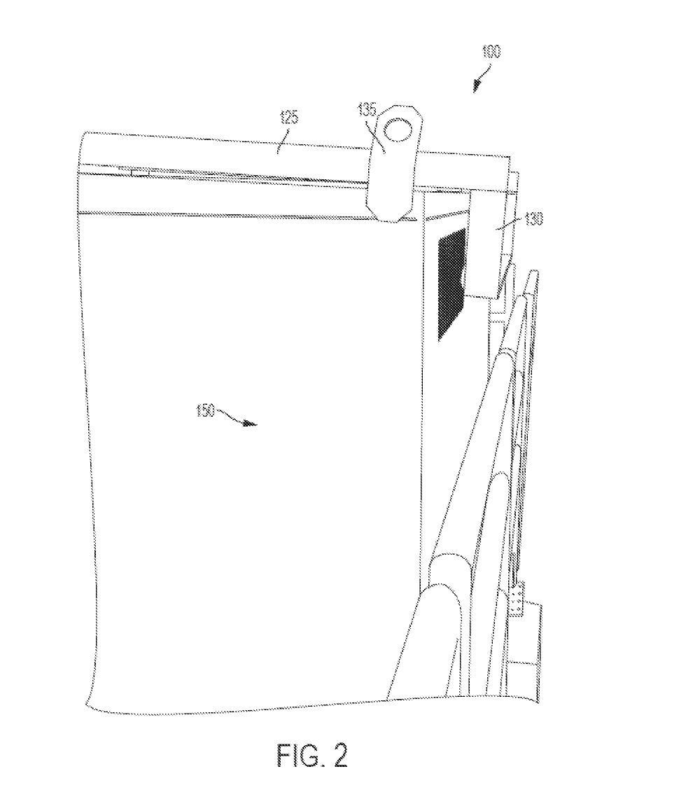

The saddle bracket 120 may include at least one longitudinal member 125 that is configured to stretch longitudinally on top of the cabinet 150 (as shown in e.g., FIG. 2), and at least one support member 130 that is projectable downward to a bend so that it prevents removal of the locking apparatus 100 from the cabinet 150. The longitudinal member 125 may include at least one horizontal bar (e.g., shown as 570 in FIG. 21).

The saddle bracket 120 and the mounting plate 110 may be molded as a single unit. In an alternative, the saddle bracket 120 and the mounting plate 110 may be two separate units that are attached to each other via e.g., adhesive, any fastening means, and the like.

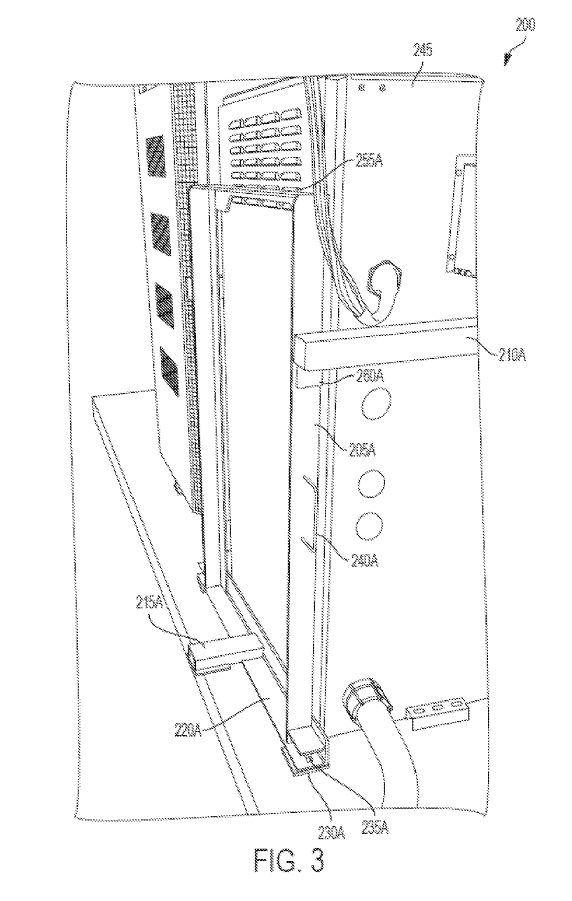

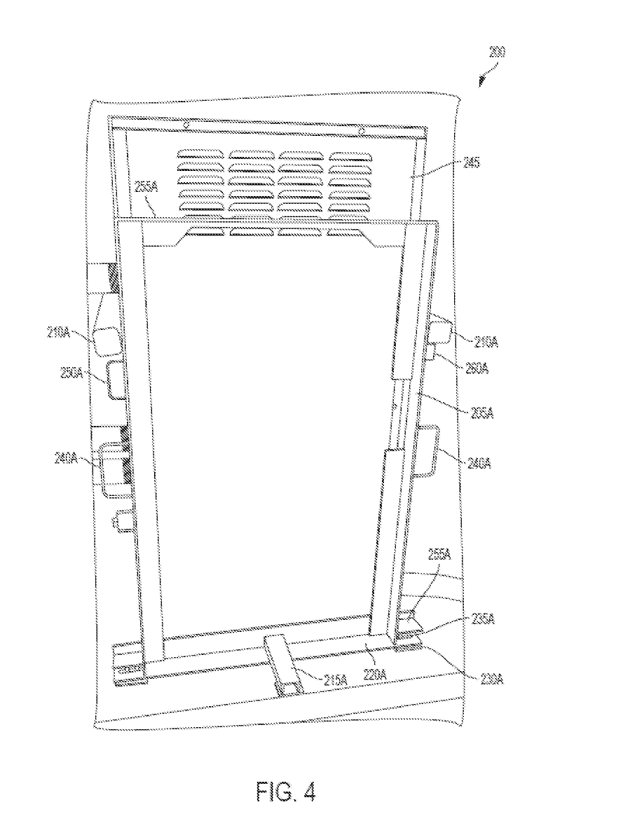

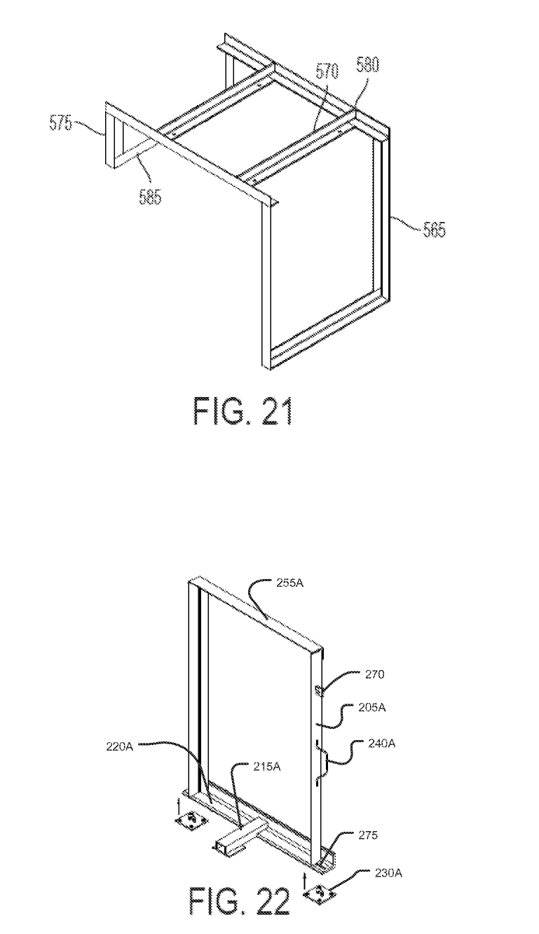

FIG. 3 shows a front perspective view of another example of a locking apparatus 200 in accordance with the principles of the present disclosure. FIG. 4 shows a front view of the locking apparatus 200. Referring to FIGS. 3-4, and 22 concurrently, the locking apparatus 200 includes a front mounting plate 220A that includes at least one slot 275, a front support bracket 205A that is projectable substantially upward from an edge of the front mounting plate 220A that includes at least one slot 275, and at least one crossover bracket 270, wherein the front support bracket 205A includes at least one handle 240A for aiding the placement and removal of the locking apparatus 200 from a cabinet 245.

The locking apparatus 200 may include at least one bracket leg 215A that protrudes forward from the mounting plate 220A and acts as a leverage to prevent the removal of locking apparatus 200.

The locking apparatus 200 may include at least one crossover tube 210A that includes at least one hole to slidably fit into the crossover bracket 270. Once the at least one crossover tube 210A fits into the crossover bracket 270, at least one lock 260A may be placed through the crossover bracket 270.

The locking apparatus 200 may be placed over at least one front mounting bracket 230A. The at least one slot 275 may be configured to slidably accept the at least one front mounting bracket 230A, and a lock 265A may be placed through a hole of the at least one front mounting bracket 230A to lock in the locking apparatus 200 to the at least one front mounting bracket 230A. The at least one front mounting bracket 230A may be affixed to a ground via e.g., an adhesive or e.g., nail, screw, and any other fastening mechanism.

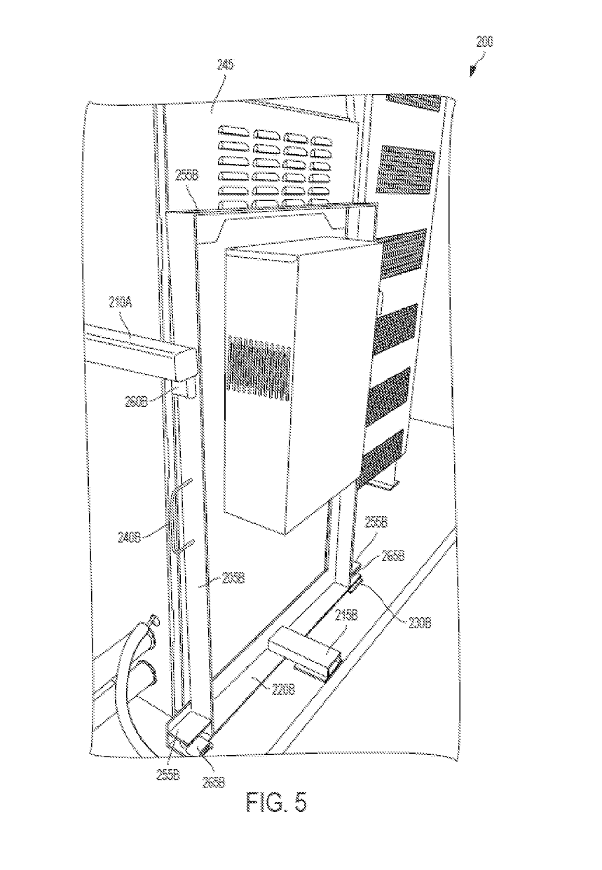

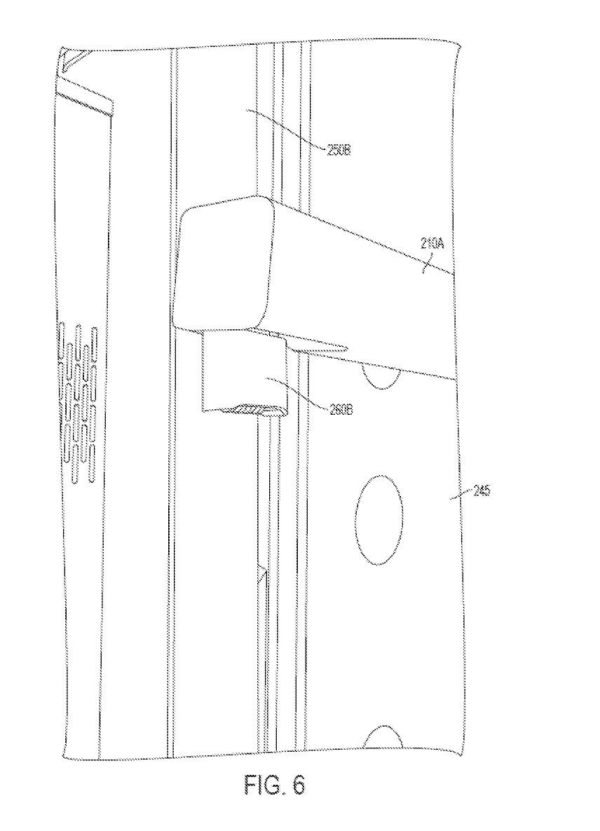

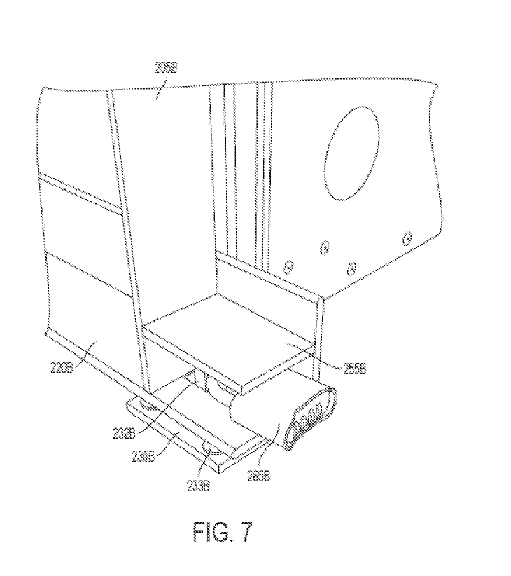

FIG. 5 shows a back perspective view of the locking apparatus 200. FIG. 6 shows a close up of a back perspective view of the locking apparatus 200. FIG. 7 shows a close-up of a bottom back view of the locking apparatus 200. Referring to FIGS. 5-7 concurrently, the back of the locking apparatus 200 includes a replicate of the front of the locking apparatus 200 as shown in FIGS. 3-4 except it is placed on back side of the cabinet 245. The locking apparatus 200 includes a back mounting plate 220B that includes at least one slot (not shown), a back support bracket 205B that is projectable substantially upward from an edge of the back mounting plate 220B, and at least one crossover bracket (not shown), wherein the back support bracket 205B includes at least one handle 240B for aiding the placement and removal of the locking apparatus 200 from the cabinet 245. The back and the front of the locking apparatus 200 may be connected to each other via the at least one crossover tube 210A.

The back of the locking apparatus 200 may be placed over at least one back mounting bracket 230B. The at least one back mounting bracket 230B, which may be identical to the at least one front mounting bracket 230A, may include a plate 232B which may include a slot that slides into the locking apparatus 200. The slot may receive at least one lock 265B so that the at least one back mounting bracket 230B and the locking apparatus 200 may be affixed to each other. The at least one back mounting bracket 230B may further include a hole (not shown) which may receive and hold a bolt 233B so that the at least one back mounting bracket 230B is affixed to a ground. The bolt 233B may include a taper.

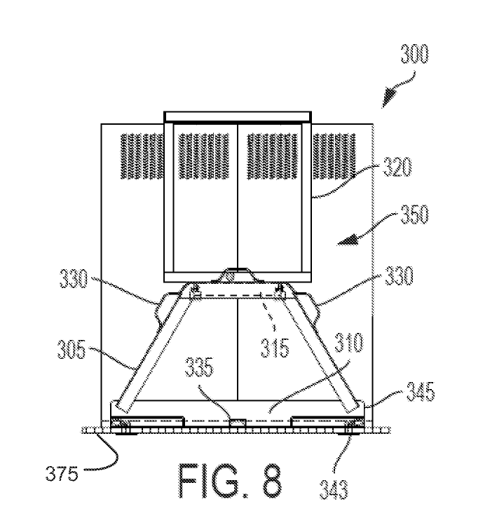

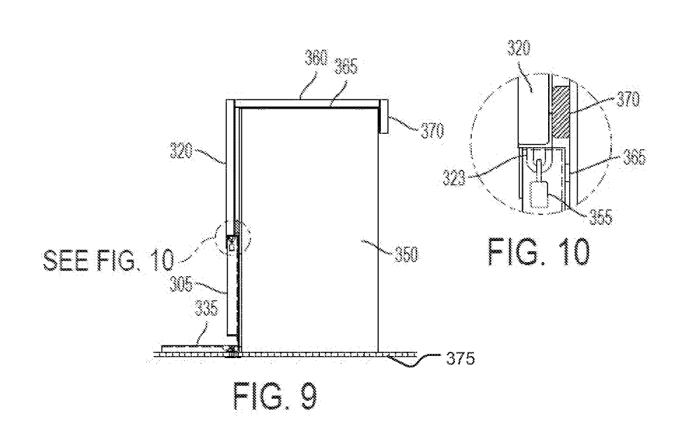

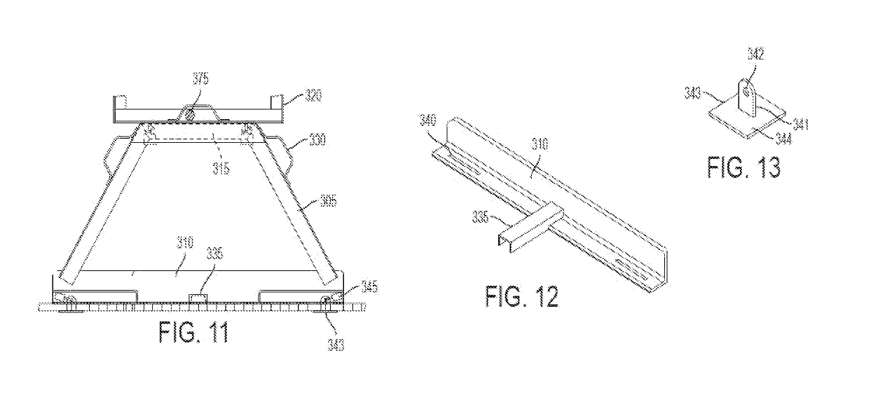

FIGS. 8-13 show an example of a locking apparatus 300 in accordance with the principles of the present disclosure. Referring to FIGS. 8-13 concurrently, the locking apparatus 300 includes a mounting plate 310, a support bracket 305 that is projectable substantially diagonally upward from an edge of the mounting plate 310 and includes at least one slot (not shown), and a saddle bracket 320 that includes at least one saddle bracket connection ear 323, wherein the at least one saddle bracket connection ear 323 is configured to slide into the at least one slot of the support bracket 305 to connect the saddle bracket 320 and the support bracket 305, and wherein the support bracket 305 includes at least one handle 330 for aiding the placement and removal of the locking apparatus 300 from a cabinet 350.

The locking apparatus 300 may include at least one lock 355, wherein the at least one lock may be placed between a slot in the at least one saddle bracket connection ear 323 once the at least one saddle bracket connection ear 323 is sled into the at least one slot of the support bracket 305. The saddle bracket 320 may conceal a lock 370 (e.g., BTS lock) on the cabinet 350. The locking apparatus 300 may further include a plate 315 for concealing the at least one lock 355. The plate 315 may include a ¼ inch thickness and may be affixed to the support bracket 305 via e.g., adhesive, a screw, or the like. In an alternative, the plate 315 and the support bracket 305 may be formed as a single unit.

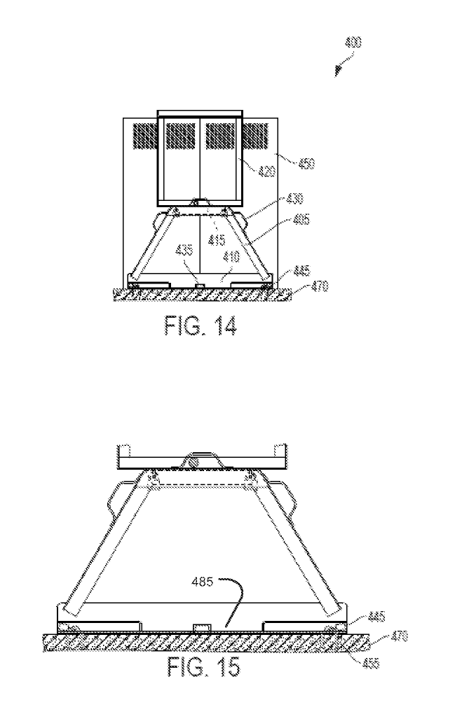

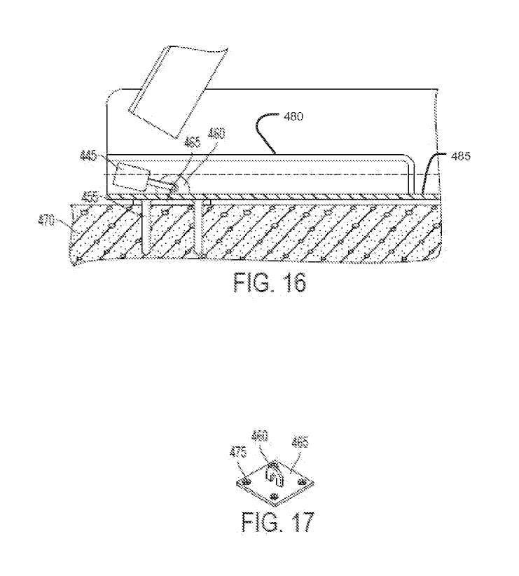

The locking apparatus 300 may include at least one bracket leg 335 that protrudes forward from the mounting plate 310 and acts as a leverage to prevent the removal of locking apparatus 100. The mounting plate 310 may include at least one slot 340 to engage with at least one mounting bracket 343. The at least one mounting bracket 343 may be welded an existing platform grating 375. In an alternative, the at least one mounting bracket may be affixed to a ground as shown in e.g., FIGS. 14-17.

Once the at least one mounting bracket 343 is engaged with the at least one slot 340, at least one lock 345 may be placed through a hole 342 in the at least one mounting bracket 343 to affix the at least one mounting bracket 343 and the mounting plate 310 together. The at least one mounting bracket 343 may include a horizontal plate 344 and a vertical plate 341. The horizontal plate 344 may include ¼ inch by 3 inch dimension. The vertical plate 342 may include ⅜ inch by ¼ inch by ½ inch plate. The hole 342 may include 11/16 inch dimension.

The support bracket 305 may further include a plurality of metal beams that form a triangular or rectangular shape configuration at an angle. The angle may include ½ inch by 2 inch or ½ inch by 3/16 inch. The support bracket 305 may include a height of 2 to 4 feet from the ground.

The saddle bracket 320 may include at least one longitudinal member 360 that is configured to stretch longitudinally on top of the cabinet 350, and at least one support member 370 that is projectable downward to a bend so that it prevents removal of the locking apparatus 300 from the cabinet 350. The longitudinal member 360 may include at least one horizontal bar (e.g., shown as 570 in FIG. 21) for reinforcement. The longitudinal member 360 may further include at least one bumper 365 that is placed between the longitudinal member 360 and the cabinet 360. The at least one bumper 365 may further include a ¼ inch bolt thick rubber bumper.

The saddle bracket 320 and the mounting plate 310 may be molded as a single unit. In an alternative, the saddle bracket 320 and the mounting plate 310 may be two separate units that are attached to each other via e.g., adhesive, any fastening means, and the like.

FIGS. 14-18 show a new form of mounting bracket in accordance with the principles of the present disclosure. FIGS. 14-18 disclose a locking apparatus 400 which is identical to the locking apparatus 300 (shown in e.g., FIG. 8) except that the locking apparatus 400 utilizes a different form of mounting bracket and method. Referring to FIGS. 14-18 concurrently, the locking apparatus 400 affixes to a ground 470 and platform grating 485 using the mounting bracket 465 which is both welded to the platform grating 485 and includes at least one drill hole 475 for e.g., bolts with taper to ensure flush mount of bolt head. The mounting bracket 465 includes at least one bolt 455 which goes through at least one drill hole 475 into a ground 470. The mounting bracket 465 is further configured to be welded to the platform grating 485.

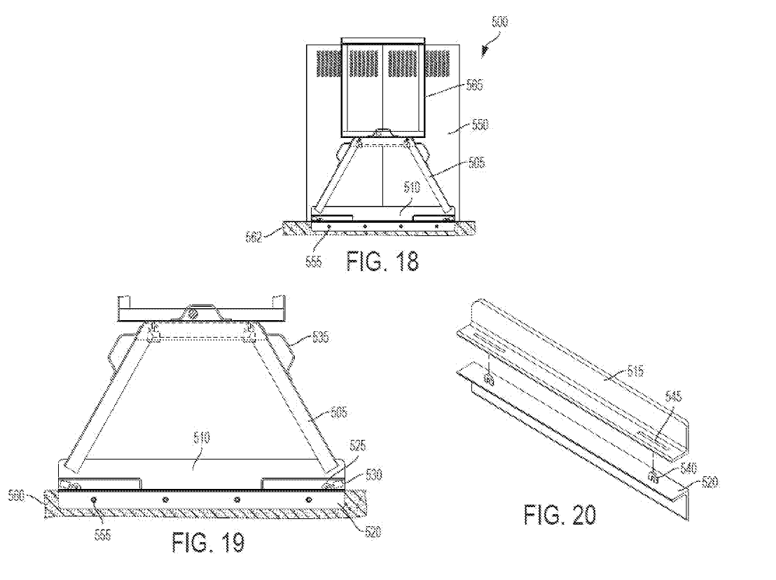

FIGS. 18-20 show a locking apparatus 500 in accordance with the principles of the present disclosure. The locking apparatus 500 includes a mounting plate 510, a support bracket 505 that is projectable substantially diagonally upward from an edge of the mounting plate 510 and includes at least one slot (not shown), and a saddle bracket 565 that includes at least one saddle bracket connection ear (not shown), wherein the at least one saddle bracket connection ear is configured to slide into the at least one slot of the support bracket 505 to connect the saddle bracket 565 and the support bracket 505, and wherein the support bracket 505 includes at least one handle 535 for aiding the placement and removal of the locking apparatus 500 from a cabinet 550.

The mounting plate 510 may include an upper portion 515 and a lower portion 520. The upper portion 515 and the lower portion 520 may be two separate units or alternatively, created as a one unit.

The upper portion 515 may be configured to have an L-shape form at an L5×3×1/4 angle. The upper portion 515 may include at least one slot 545. The lower portion 520 may include at least one lock attachment clip 540. The lower portion 520 may further be embedded into a ground 560 (e.g., concrete pad) and may include at least one sleeve anchor 555. The lower portion 520 may be embedded into the ground by minimum of 2 inches. The at least one sleeve anchor 555 may include at least one thread (not shown) that is peened after the lower portion 520 is embedded into the ground. Once the lower portion 520 is embedded, the upper portion 515 may be placed on top of the lower portion 520 so that the at least one lock attachment clip 540 is inserted into the at least one slot 545. Afterwards, a lock (e.g., combo lock, key lock, biometric lock, and the like) may be placed through a hole in the at least one lock attachment clip 540 thereby binding the affixed lower portion 520 to the upper portion 515.

The at least one slot 545 may include 7/16 inch by 12 inch hole. The at least one slot 545 may be placed about 2 inches away from an edge of the upper portion 515.

The at least one lock attachment clip may be configured to be placed about 3 inches from an edge of the lower portion 520. The lower portion 520 may further include another lock attachment clip near the opposing edge of the lower portion 520 wherein the distance between the two lock attachment clips may be around 3 feet 3 inches.

While the disclosure has been described in terms of exemplary embodiments, those skilled in the art will recognize that the disclosure can be practiced with modifications in the spirit and scope of the appended claim, drawings and attachment. The examples provided herein are merely illustrative and are not meant to be an exhaustive list of all possible designs, embodiments, applications or modifications of the disclosure.

What is claimed is:

1. A locking apparatus for securing a panel cabinet, comprising:
a mounting plate that comprises at least one slot;
a support bracket that is projectable substantially diagonally upward from one end of the mounting plate, extend horizontally in parallel to the mounting plate, and is then projectable substantially diagonally downward to an opposing end of the mounting plate;
a saddle bracket that comprises at least one saddle bracket connection ear is configured to be attachable to the support bracket; and
wherein the mounting plate, the support bracket, and the saddle bracket comprise a frame that is placed on top of the panel cabinet.

2. The locking apparatus of claim 1, wherein the support bracket comprises at least one handle for aiding placement and removal of the locking apparatus.

3. The locking apparatus of claim 1, wherein the support bracket comprises at least one slot that is configured to slidably accept the at least one saddle bracket connection ear.

4. The locking apparatus of claim 1, wherein the mounting plate comprises:
an upper portion; and
a lower portion,
wherein the upper portion comprises at least one slot,
wherein the lower portion comprises at least one lock attachment clip that is configured to slidably fit into the at least one slot on the upper portion to affix the upper portion to the lower portion,
wherein the lower portion is configured to be embedded into the ground, and
wherein once the lower portion is embedded into the ground, the upper portion is placed on top of the lower portion and a lock is placed on the at least one lock attachment clip.

5. The locking apparatus of claim 1, further comprising at least one bracket leg that protrudes forward from the mounting plate.

6. The locking apparatus of claim 1, further comprising a mounting bracket that is configured to be removably attached to the mounting plate.

7. The locking apparatus of claim 6, wherein the mounting bracket further comprises at least one clip that is configured to slidably fit into the at least one slot on the mounting plate.

8. The locking apparatus of claim 7, wherein the mounting bracket is configured to be affixed to a ground by a fastener.

9. The locking apparatus of claim 7, wherein the mounting bracket is configured to be welded to an existing platform grating.

10. The locking apparatus of claim 7, wherein a lock is placed on the at least one clip once the at least one clip slidably fit into the at least one slot on the mounting plate to affix the mounting bracket and the mounting plate.

11. The locking apparatus of claim 8, wherein the fastener comprises:
a push button;
a pin;
a lock;
a clip;
a clamp;
a bolt; or
a screw.

12. The locking apparatus of claim 1, wherein the support bracket comprises at least one slot wherein the at least one slot is configured to slidably accept the at least one saddle bracket connection ear.

13. The locking apparatus of claim 12, wherein once the at least one saddle bracket connection ear is slidably fit into the at least one slot, a lock is placed on the connection ear to affix the saddle bracket to the support bracket.

14. The locking apparatus of claim 1, wherein the saddle bracket comprises:
at least one longitudinal member that is configured to stretch longitudinally on top of the cabinet; and
at least one support member that is projectable downward to a bend so that it prevents removal of the locking apparatus from the cabinet.

15. A locking apparatus for securing a panel cabinet comprising:
a mounting plate that comprises at least one slot; and
a support bracket that is projectable substantially diagonally upward from one end of the mounting plate, extend horizontally in parallel to the mounting plate, and is then projectable substantially diagonally downward to an opposing end of the mounting plate,
wherein the mounting plate and the support bracket comprise a frame that is placed on the panel cabinet.

16. The locking apparatus of claim 15, wherein the support bracket further comprises at least one crossover bracket that is configured to accept and hold at least one crossover tube and is further configured to accept a lock to hold the at least one crossover bracket and the at least one crossover tube together.

17. The locking apparatus of claim 16, wherein two replicates of the frame are configured to be placed on both front and back of the cabinet, and wherein the two replicates of the frame are further configured to be removably attached to each other via the crossover tube.

18. The locking apparatus of claim 15, wherein the frame is configured to be removably placed over a mounting bracket.

19. A method of securing a panel cabinet, the method comprising:
providing a mounting plate that comprises at least one slot; and
attaching a support bracket to the mounting plate, the support bracket being configured to project substantially diagonally upward from one end of the mounting plate, extend horizontally in parallel to the mounting plate, and is then projectable substantially diagonally downward to an opposing end of the mounting plate, and
wherein the mounting plate and the support bracket comprise a frame that is configured to be placed over the panel cabinet.

20. The method according to claim 19, further comprising a mounting bracket that is configured to be removably attached to the mounting plate.
